(19) United States
(12) Patent Application Publication
(10) Pub. No.: US 2010/0167063 A1
(43) Pub. Date: Jul. 1, 2010

(54) PAPER COATING COMPOUNDS CONTAINING SILICASOLS

(75) Inventors: Dirk Lawrenz, Hassloch (DE); Peter Schlichting, Bratislava (SK); Albert Walter, Frankenthal (DE); Hermann Seyffer, Heidelberg (DE); Marc Schroeder, Heidelberg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/376,989

(22) PCT Filed: Aug. 6, 2007
(86) PCT No.: PCT/EP07/58101

§ 371 Date: Feb. 10, 2009

(30) Foreign Application Priority Data
Aug. 14, 2006 (EP) 06118852.0

(51) Int. Cl. B32B 29/04; C08L 33/10; C08L 31/02; C08L 33/18; C08L 27/00; C08L 9/00; C08L 9/06

(52) U.S. Cl. 428/438; 524/560; 524/563; 524/543; 524/565; 524/567; 524/570; 524/571; 524/525; 524/523

(57) ABSTRACT

Paper coating slips comprising at least one pigment and
A) an aqueous polymer dispersion obtainable by emulsion polymerization (emulsion polymer for short) and
B) a polysilicic acid dissolved or dispersed in water or dispersed silica (summarized as silica sol).

The present invention relates to paper coating slips comprising at least one pigment and
A) an aqueous polymer dispersion obtainable by emulsion polymerization (emulsion polymer for short) and
B) a polysilicic acid dissolved or dispersed in water or dispersed silica (summarized as silica sol).

In addition to water, paper coating slips generally comprise binders, pigments and further assistants, e.g. thickeners.

For simple and problem-free processing of the aqueous paper coating slip, it is desirable for the paper coating slip overall to have a low viscosity. A low viscosity also permits a higher solids content. Since less water has to be removed during the drying, energy costs can also be reduced.

The constituents of the paper coating slip must therefore be tailored to one another so that the viscosity is low and the performance characteristics of the coated paper, for example resistance to mechanical loads, in particular pick resistance, optical appearance, e.g. smoothness and gloss, and the printability are as good as possible.

WO 02/48459 discloses paper coating slips whose viscosity is reduced by adding highly crosslinked polyester amides.

EP-A-1 479 744 describes the addition of polymeric silicon compounds, e.g. of water-soluble alkali metal silicates, to contact adhesives in order to improve the adhesion.

Paper coating slips having low viscosity and good performance characteristics were an object of the present invention.

Accordingly, the paper coating slips defined above were found.

According to the invention, the paper coating slip comprises an emulsion polymer A) and a polysilicic acid dissolved or dispersed in water or dispersed silica B) (summarized as silica sol).

Re Emulsion Polymer A)

The emulsion polymer preferably comprises at least 40% by weight, preferably at least 60% by weight, particularly preferably at least 80% by weight, of so-called main monomers.

The main monomers are selected from C₁-C₂₀-alkyl (meth)acrylates, vinyl esters of carboxylic acids comprising up to 20 carbon atoms, vinyl aromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds or mixtures of these monomers.

For example, alkyl (meth)acrylates having a C₁-C₁₀-alky radical, such as methyl methacrylate, methyl acrylate, n-butyl acrylate, ethyl acrylate and 2-ethylhexyl acrylate, may be mentioned.

Mixtures of the alkyl (meth)acrylates are also particularly suitable.

Vinyl esters of carboxylic acids having 1 to 20 carbon atoms are, for example, vinyl laurate, vinyl stearate, vinyl propionate, vinyl versatate and vinyl acetate.

Suitable vinylaromatic compounds are vinyl toluene, α- and p-methyl styrene, α-butylstyrene, 4-n-butylstyrene, 4-n-decylstyrene and preferably styrene. Examples of nitriles are acrylonitrile and methacrylonitrile.

The vinyl halides are ethylenically unsaturated compounds substituted by chlorine, fluorine or bromine, preferably vinyl chloride and vinylidene chloride.

For example, vinyl methyl ether or vinyl isobutyl ether may be mentioned as vinyl ethers. Vinyl ethers of alcohols comprising 1 to 4 carbon atoms are preferred.

Ethylene, propylene, butadiene, isoprene and chloroprene may be mentioned as hydrocarbons having 2 to 8 carbon atoms and one or two olefinic double bonds.

Preferred main monomers are C₁-C₁₀-alkyl (meth)acrylates and mixtures of the alkyl (meth)acrylates with vinylaromatics, in particular styrene (also summarized as polyacrylate binders) or hydrocarbons having 2 double bonds, in particular butadiene, or mixtures of such hydrocarbons with vinylaromatics, in particular styrene (also summarized as polybutadiene binders).

In the case of polybutadiene binders, the weight ratio of butadiene to vinylaromatics (in particular styrene) may be, for example, from 10:90 to 90:10, preferably from 20:80 to 80:20.

Polybutadiene binders are particularly preferred.

In addition to the main monomers, the polymer may comprise further monomers, for example monomers having carboxyl, sulfo or phosphonic acid groups. Carboxyl groups are preferred. For example, acrylic acid, methacrylic acid, itaconic acid, maleic acid or fumaric acid and aconitic acid may be mentioned. The content of ethylenically unsaturated acids in the emulsion polymer is in general less than 5% by weight.

Further monomers are, for example, also monomers comprising hydroxyl groups, in particular C₁-C₁₀-hydroxyalkyl (meth)acrylates, or amides such as (meth)acrylamide.

The polymers are prepared by emulsion polymerization and are therefore emulsion polymers.

In the emulsion polymerization, ionic and/or nonionic emulsifiers and/or protective colloids or stabilizers are used as surface-active compounds.

The surface-active substance is usually used in amounts of from 0.1 to 10% by weight, based on the monomers to be polymerized.

Water-soluble initiators for the emulsion polymerization are, for example, ammonium and alkali metal salts of peroxodisulfuric acid, e.g. sodium peroxodisulfate, hydrogen peroxide or organic peroxides, e.g. tert-butyl hydroperoxide.

So-called reduction-oxidation (redox) initiator systems are also suitable.

The amount of the initiator is in general from 0.1 to 10% by weight, preferably from 0.5 to 5% by weight, based on the monomers to be polymerized. It is also possible to use a plurality of different initiators in the emulsion polymerization.

In the polymerization, it is possible to use regulators, for example in amounts of from 0 to 3 parts by weight, based on 100 parts by weight of the monomers to be polymerized, by means of which regulators the molar mass is reduced. For example, compounds having a thiol group, such as tert-butyl mercaptan, ethylacryloyl thioglycolate, mercaptoethynol, mercaptopropyltrimethoxysilane or tert-dodecyl mercaptan or regulators without a thiol group, in particular, for example, terpinolene, are suitable.

The emulsion polymerization is effected as a rule at from 30 to 130° C., preferably from 50 to 100° C. The polymerization medium may consist either only of water or of mixtures of water and liquids miscible therewith, such as methanol. Preferably, only water is used. The emulsion polymerization can be carried out either as a batch process or in the form of a feed process, including a step or gradient procedure. The feed process is preferred, in which a part of the polymerization batch is initially taken, heated to the polymerization temperature and prepolymerized and then the remainder of the polymerization batch is fed to the polymerization zone, usually via a plurality of spatially separated feeds, one or more of which comprises the monomers in pure or in emulsified form, continuously, stepwise or with superposition of a concentration gradient, while maintaining the polymerization. In the polymerization, a polymer seed may also be initially taken, for example for better adjustment of the particle size.

The manner in which the initiator is added to the polymerization vessel in the course of the free radical aqueous emulsion polymerization is known to the average person skilled in the art. It may be either completely initially taken in the polymerization vessel or used continuously or stepwise at the rate of its consumption in the course of the free radical aqueous emulsion polymerization. Specifically, this depends on the chemical nature of the initiator system as well as on the polymerization temperature. Preferably, a part is initially taken and the remainder is fed to the polymerization zone at the rate of consumption.

For removing the residual monomers, initiator is usually also added after the end of the actual emulsion polymerization, i.e. after a conversion of the monomers of at least 95%.

In the feed process, the individual components can be added to the reactor from above, at the side or from below through the reactor bottom.

In the emulsion polymerization, aqueous dispersions of the polymer as a rule having solids contents of from 15 to 75% by weight, preferably from 40 to 75% by weight, are obtained.

Re Silica Sol B)

Starting from silicic acid (Si(OH)₄), silicic acid chains (polysilicic acid) initially form by condensation, and finally 3-dimensional silica networks (silica particles) form by further condensation of the OH side groups too. Polysilicic acids are silica particles dissolved or dispersed in water as summarized by the term silica sol. The polysilicic acids are generally still water-soluble; owing to their particle structure, the silica particles are present as dispersions of these particles in water (also referred to as colloidal solutions).

Aqueous dispersions of silica particles are preferred. On the surface, the particles carry hydroxyl groups which are not condensed for the formation of silica structures. These hydroxyl groups result in self-dispersibility of the silica particles; concomitant use of other surface-active assistants is therefore not required.

The average particle size of the silica particles is preferably from 2 to 100 nm and particularly preferably from 5 to 75 nm (weight average).

The silicic acids or silica particles may also comprise further constituents or impurities, e.g. metal atoms, which partly replace hydrogen atoms, or are contaminated by other minerals. The content of such constituents or impurities is preferably less than 5% by weight, particularly preferably less than 1% by weight, based on the silica sol (solid).

Suitable silica sols are obtainable, for example, from H.C. Starck under the trade name Levasil®.

The silica sol B) can preferably be added in simple manner to the polymer dispersion of A) obtained by emulsion polymerization.

Re Paper Coating Slip

Paper coating slips comprise, as constituents, in particular
a) one or more binders
b) if appropriate, a thickener
c) if appropriate, a fluorescent or phosphorescent dye, in particular as an optical brightener
d) pigments
e) silica sol
f) further assistants, e.g. leveling agents or other dyes.

In addition to the above emulsion polymer, further binders, for example including natural polymers, such as starch, can be concomitantly used as binders. The proportion of the emulsion polymer is preferably at least 50% by weight, particularly preferably at least 70% by weight, based on the total amount of binder. The paper coating slips comprise binder preferably in amounts of from 1 to 50 parts by weight, particularly preferably from 5 to 20 parts by weight of binder, based on 100 parts by weight of pigment.

In addition to synthetic polymers, suitable thickeners b) are in particular celluloses, preferably carboxymethylcellulose.

The term pigment d) is understood here as meaning inorganic solids. These solids as pigments are responsible for the color of the paper coating slip (in particular white) and/or merely have the function of an inert filler. The pigment generally comprises white pigments, e.g. barium sulfate, calcium carbonate, calcium sulfoaluminate, kaolin, talc, titanium dioxide, zinc oxide, chalk or coating clay or silicates.

Suitable silica sols e) are mentioned above. The content of the silica sol in the paper coating slip is preferably from 0.1 to 30 parts by weight, particularly preferably from 0.1 to 15 parts by weight and very particularly preferably from 0.5 to 10 and in particular from 0.5 to 5 parts by weight, per 100 parts by weight of pigment.

The paper coating slip can be prepared by conventional methods. Preferably, the mixture of A) and B) is prepared separately beforehand and only thereafter added to the paper coating slip, i.e. mixed with the further constituents, in particular the pigment.

The paper coating slips according to the invention have a low viscosity and are suitable for the coating of, for example, base paper or cardboard. The coating and subsequent drying can be effected by conventional methods. The coated papers or cardboards have good performance characteristics; in particular they are also readily printable in the known printing processes, such as flexographic, letterpress, gravure or offset printing. Especially in the offset process, they result in a high pick resistance and rapid and good ink and water acceptance. The papers coated with the paper coating slips can readily be used in all printing processes, in particular in the offset process.

### EXAMPLES

A paper coating slip was prepared from the constituents stated in the table by mixing, and the viscosity was measured.

The Brookfield viscosity was measured at 100 rpm and is stated in mPa·s. The silica sol used was Levasil® 100/45 from H.C. Starck (100 specifies the specific surface area (square meters per gram), and 45 the concentration in water).

Experiments on viscosity reduction of paper coating slips

| | Composition | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| | Data for amounts used, in each case calculated as solid | | | | | | | | | | | |
| Setacarb ®GU, | 80.0 | 80.0 | 80.0 | 80.0 | 75.0 | 70.0 | 60.0 | 60.0 | 60.0 | 60.0 | 60.0 | 60.0 |
| ground calcium | | | | | | | | | | | | |
| carbonate, from Omya | | | | | | | | | | | | |
| Gasil ®35 M, silica pigment, | 20.0 | 15.0 | 10.0 | 5.0 | 10.0 | 15.0 | 5.0 | 15.0 | 10.0 | 5.0 | 10.0 | 7.0 |
| mean particle size about 4 μm | | | | | | | | | | | | |
| Hydrocarb ® 90, | | | | | | | 20.0 | 20.0 | 20.0 | 20.0 | 20.0 | 20.0 |
| ground calcium | | | | | | | | | | | | |
| carbonate, from Omya | | | | | | | | | | | | |
| Levasil ®100/45, silica sol | | 5.0 | 10.0 | 15.0 | 15.0 | 15.0 | 15.0 | 5.0 | 10.0 | 15.0 | 10.0 | 13.0 |
| Polysalz, dispersant based | 0.20 | 0.20 | 0.20 | 0.20 | 0.20 | 0.20 | 0.20 | 0.20 | 0.20 | 0.20 | 0.20 | 0.20 |
| on polyacrylic acid | | | | | | | | | | | | |
| Styronal ®D 809, styrene/ | 9.0 | 9.0 | 9.0 | 9.0 | 9.0 | 9.0 | 9.0 | 9.0 | 9.0 | 9.0 | 9.0 | 9.0 |
| butadiene binder | | | | | | | | | | | | |
| PVA BK 05 | 1.0 | 1.0 | 1.0 | 1.0 | 1.0 | 1.0 | 1.0 | 1.0 | 1.0 | 1.0 | 1.0 | 1.0 |
| (polyvinyl alcohol) | | | | | | | | | | | | |
| Blankophor ® PSG, | 0.5 | 0.5 | 0.5 | 0.5 | 0.5 | 0.5 | 0.5 | 0.5 | 0.5 | 0.5 | 0.5 | 0.5 |
| optical brightener | | | | | | | | | | | | |
| Sterocoll ®FD, rheology | | | | 0.13 | 0.07 | | 0.13 | | | 0.10 | | 0.07 |
| assistant, thickener | | | | | | | | | | | | |
| Water for establishing the | | | | | | | | | | | | |
| desired solids content | | | | | | | | | | | | |
| Properties: | | | | | | | | | | | | |
| pH | 8.6 | 8.7 | 8.8 | 8.7 | 8.7 | 8.8 | 8.7 | 8.7 | 8.7 | 8.7 | 8.7 | 8.7 |
| Brookfield viscosity | 7790 | 1468 | 948 | 768 | 1156 | 1698 | 932 | 2356 | 888 | 1052 | 888 | 1032 |
| Haake viscosity | Not | 95.69 | 48.18 | 32.86 | 57.25 | 84.45 | 31.92 | 99.63 | 52.00 | 41.44 | 52.01 | 46.75 |
| | measurable | | | | | | | | | | | |
| Solids content in % | 59.8 | 60.1 | 59.4 | 59.5 | 59.5 | 59.9 | 59.2 | 59.6 | 59.0 | 59.7 | 59.2 | 59.2 |

1. A paper coating slip comprising at least one pigment and
A) an aqueous polymer dispersion obtained by emulsion polymerization and
B) a silica sol which is polysilicic acid dissolved or dispersed in water or dispersed silica.

2. The paper coating slip according to claim 1, wherein
said aqueous polymer dispersion comprises at least 40% by weight of main monomers selected from the group consisting of
a C₁- to C₂₀-alkyl (meth)acrylate,
a vinyl ester of a carboxylic acid comprising up to 20 carbon atoms,
a vinylaromatic having up to 20 carbon atoms,
an ethylenically unsaturated nitrile,
a vinyl halide,
a vinyl ether of an alcohol comprising 1 to 10 carbon atoms,
an aliphatic hydrocarbon having 2 to 8 carbon atoms and one or two double bonds
and a mixture thereof.

3. The paper coating slip according to claim 1, wherein said aqueous polymer dispersion comprises at least 60% by weight of
butadiene,
a mixture of butadiene and styrene,
a C₁- to C₂₀-alkyl (meth)acrylate, or
a mixture of a C₁- to C₂₀-alkyl (meth)acrylate and styrene.

4. The paper coating slip according to claim 1, wherein the silica sol is an aqueous dispersion of silica particles which have hydroxyl groups on the surface.

5. The paper coating slip according to claim 1, wherein the amount of silica sol is from 0.1 to 30 parts by weight per 100 parts by weight of pigment.

6. A paper coated with a paper coating slip according to claim 1.
